(19) United States
(12) Patent Application Publication
(10) Pub. No.: US 2024/0077899 A1
(43) Pub. Date: Mar. 7, 2024

(54) Voltage Regulator Circuit

(71) Applicant: TEXAS INSTRUMENTS INCORPORATED, Dallas, TX (US)

(72) Inventors: Ashutosh CHITNIS, Ambernath (IN); Rajat CHAUHAN, Bangalore (IN); Divya KAUR, Delhi (IN)

(21) Appl. No.: 18/173,142

(22) Filed: Feb. 23, 2023

(30) Foreign Application Priority Data
Sep. 1, 2022 (IN) 202241049878

(51) Int. Cl. G05F 1/575; G05F 1/46; G05F 1/565; G05F 3/26

(52) U.S. Cl. CPC G05F 1/575; G05F 1/463; G05F 1/565; G05F 3/262

(57) ABSTRACT

A circuit includes a load circuit and a voltage regulator circuit. The load circuit includes a load voltage input, a first transistor and a second transistor. The first transistor has a first threshold voltage, and the second transistor has a second threshold voltage. The voltage regulator circuit includes a load voltage output and a tracking circuit. The load voltage output is coupled to the load voltage input. The tracking circuit is configured to provide a load voltage at the load voltage output in which the load voltage tracks the first threshold voltage and the second threshold voltage.

### CROSS-REFERENCE TO RELATED APPLICATIONS

This application claims priority to India Provisional Application No. 202241049878, filed Sep. 1, 2022, entitled “Nano-Ampere, Minimum Supply Tracking Sub-Regulator Circuit”, which is hereby incorporated by reference.

### BACKGROUND

The operating voltage provided to power an electronic circuit may be limited to a selected range to enable the desired operation of the electronic circuit. For example, proper operation of an electronic circuitry may be guaranteed only if the voltage powering the circuit is within a given range. Switching regulators and linear regulators are examples of voltage regulation circuits that can be used to limit the operating voltage provided to an electronic circuit.

### SUMMARY

Voltage regulator circuits that track the threshold voltages of load circuit transistors are described herein. In one example, a circuit includes a transistor, a tracking circuit, and a margin circuit. The transistor is coupled between an input voltage terminal and an output voltage terminal. The transistor has a control input. The tracking circuit has a first input, a second input and an output. the first input is coupled to the output voltage terminal. The second input is coupled to the control input. The margin circuit is coupled between the output and a ground terminal.

In another example, a circuit includes a load circuit and a voltage regulator circuit. The load circuit includes a load voltage input, a first transistor and a second transistor. The first transistor has a first threshold voltage, and the second transistor has a second threshold voltage. The voltage regulator circuit includes a load voltage output and a tracking circuit. The load voltage output is coupled to the load voltage input. The tracking circuit is configured to provide a load voltage at the load voltage output in which the load voltage tracks the first threshold voltage and the second threshold voltage.

In a further example, a circuit includes a load circuit and a voltage regulator circuit. The load circuit includes a load voltage input, a first transistor and a second transistor. The first transistor has a first threshold voltage, and the second transistor has a second threshold voltage. The voltage regulator circuit includes an input voltage terminal, a load voltage output, a pass transistor, a tracking circuit, a margin circuit, and a startup circuit. The load voltage output is coupled to the load voltage input. The pass transistor is coupled between the input voltage terminal and the load voltage output. The pass transistor has a control input. The tracking circuit is coupled between the load voltage output and the control input. The tracking circuit is configured to provide a load voltage at the load voltage output in which the load voltage tracks the first threshold voltage and the second threshold voltage. The margin circuit is coupled between the tracking circuit and a ground terminal. The margin circuit is configured to set the load voltage to be a predetermined margin voltage greater than the first threshold voltage and the second threshold voltage. The startup circuit is coupled to the pass transistor and the tracking circuit. The startup circuit is configured to provide a current to the control input, the current based on the load voltage.

### BRIEF DESCRIPTION OF THE DRAWINGS

FIG. 1 is a block diagram of an example voltage regulator circuit.

FIGS. 2 and 3 are schematic diagrams of example voltage regulator circuits.

FIG. 4 is a graph showing example tracking of load transistor voltage thresholds in the voltage regulator circuits of FIG. 1, 2, or 3.

FIG. 5 is a block diagram of an example system that includes the voltage regulator circuit of FIG. 1, 2, or 3.

### DETAILED DESCRIPTION

To reduce power consumption in an electronic system, circuitry that is not needed at a particular time may be powered down. However, some circuitry must remain powered throughout system operation (“always-on circuitry”) to provide supervisory or management services. Watchdog timers, supply voltage supervisors, and power management units are examples of devices with circuits that remain powered throughout system operation. To reduce die area, some circuitry (e.g., digital circuitry) that must remain powered is implemented with thin-oxide transistors, and a voltage regulator is needed to protect the transistors.

In addition to providing protection, the voltage regulator should supply a voltage that reduces the switching and leakage power of the transistors across process and temperature variations. For example, switching and leakage power may increase with the voltage provided by the voltage regulator. While the digital circuits may operate with any voltage greater than the threshold voltage of the transistors (plus a margin voltage), the margin should be selected to reduce or minimize the power consumption of the digital circuit. The voltage regulator should start up quickly (e.g., within a few hundred microseconds) to enable operation of the powered circuitry, and consume low quiescent current.

Low drop out regulators and open-loop sub-regulators are examples of voltage regulator circuits that can be used to power circuitry that must remain powered throughout system operation. A low drop out regulator provides a precise output voltage regardless of line and load variations, but may have a large circuit area and a high quiescent current. Open-loop sub-regulators may have low quiescent current and small circuit area, but, because open-loop sub-regulators lack feedback, they don't provide a precise output voltage over line and load variations.

The example voltage regulator circuit described herein consumes low quiescent current while occupying a small circuit area. Furthermore, the example voltage regulator circuit includes a tracking circuit that tracks the minimum voltage needed to power the transistors of a load circuit across process, temperature, line, and load variations. The example voltage regulator also includes a startup circuit that ensures quick output voltage stabilization.

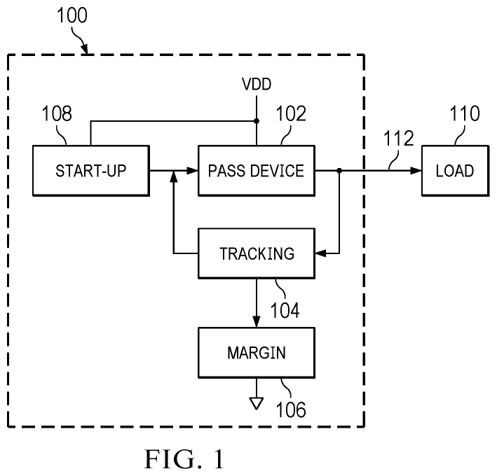

FIG. 1 is a block diagram of an example voltage regulator circuit 100. The voltage regulator circuit 100 is coupled to, and provides an output voltage to, a load circuit 110. The voltage regulator circuit 100 and the load circuit 110 may be fabricated on a same integrated circuit. The voltage regulator circuit 100 includes a pass device 102, a tracking circuit 104, a margin circuit 106, and start-up circuit 108. The pass device 102 may include a transistor coupled between a power terminal (e.g., VDD terminal) and an output of the voltage regulator circuit 100. A load voltage input of the load circuit 110 is coupled to the output of the voltage regulator circuit 100. The pass device 102 controls current flow from the power terminal to the load circuit 110 to regulate the output voltage 112 provided to the load circuit 110.

The tracking circuit 104 is coupled between an output of the pass device 102 (the output of the voltage regulator circuit 100) and a control input of the pass device 102. The tracking circuit 104 modulates the voltage at the control input of the pass device 102 to regulate the output voltage 112 provided by the voltage regulator circuit 100. The tracking circuit 104 includes transistors of the same type (fabricated using a same process) as the transistors of the load circuit 110 that are powered by the output voltage 112. The threshold voltages of the transistors of the tracking circuit 104 determine the point of regulation of the output voltage 112. Because the voltage regulator circuit 100 and the load circuit 110 are fabricated on the same integrated circuit, the threshold voltages of the transistors in the load circuit 110 and the transistors in the tracking circuit 104 are the same or close to the same. As the threshold voltages of the transistors included in the load circuit 110 change over process, voltage, and temperature, the threshold voltages of the transistors in the tracking circuit 104 change in the same way to ensure that the output voltage 112 tracks the threshold voltages of the transistors in the load circuit 110.

The margin circuit 106 is coupled between the tracking circuit 104 and a ground terminal. The margin circuit 106 sets a voltage (a margin voltage) that increases the output voltage 112 by the margin voltage above the threshold voltage established by the tracking circuit 104. Accordingly, the output voltage 112 may exceed the threshold voltage of the transistors of the load circuit 110 by the margin voltage set by the margin circuit 106 while tracking the threshold voltage. The margin circuit 106 may include transistors or resistors to set the margin voltage.

The start-up circuit 108 is coupled between the power terminal and the control input of the pass device 102. The start-up circuit 108 controls current flow from the power terminal to the control input of the pass device 102 based on the output voltage 112. If the voltage regulator circuit 100 is off (e.g., the output voltage 112 is zero volts) the start-up circuit 108 increases the current flowing to the control input of the pass device 102 to increase the current flowing through the pass device 102 and increase the output voltage 112. As the output voltage 112 increases, the current flowing through the start-up circuit 108 to the control input of the pass device 102 decreases. By providing increased current flow to the control input of the pass device 102 during startup, the start-up circuit 108 decreases the startup time (the time needed to provide a regulated voltage at the output) of the voltage regulator circuit 100.

The voltage regulator circuit 100 provides an output voltage 112 that tracks the threshold voltage of the transistors of the load circuit 110 (with a margin defined by the margin circuit 106). Controlling the output voltage 112 in this way, the voltage regulator circuit 100 reduces the power consumption of the load circuit 110 while ensuring adequate operational voltage. The voltage regulator circuit 100 starts up quickly and has low quiescent current consumption.

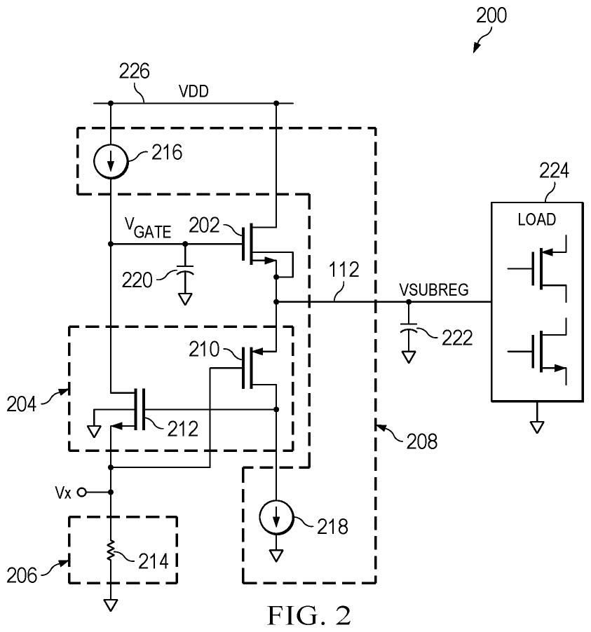

FIG. 2 is a schematic diagram of an example voltage regulator circuit 200. The voltage regulator circuit 200 is an implementation of the voltage regulator circuit 100. The voltage regulator circuit 200 includes a pass transistor 202, a tracking circuit 204, a margin circuit 206, and a startup circuit 208. The pass transistor 202 may be part of the pass device 102. The tracking circuit 204, the margin circuit 206, and the startup circuit 208 are implementations of the tracking circuit 104, the margin circuit 106, and the start-up circuit 108 respectively. The voltage regulator circuit 200 is coupled to a load circuit 224. The voltage regulator circuit 200 and the load circuit 224 may be parts of a same integrated circuit. The load circuit 224 has circuits (e.g., digital circuits) that include n-channel field effect transistors (NFETs) and p-channel field effect transistors (PFETs).

The pass transistor 202 is coupled between a power terminal 226 and the output of the voltage regulator circuit 200. The voltage regulator circuit 200 conducts current from the power terminal 226 to the output capacitor 222 and the load circuit 224 to generate the output voltage 112. A first current terminal (e.g., drain) of the pass transistor 202 is coupled to the power terminal 226, and a second current terminal (e.g., source) of the pass transistor 202 is coupled to the output of the voltage regulator circuit 200 and the load circuit 224. A capacitor 220 is coupled to the control input (e.g., gate) of the pass transistor 202. The voltage across the capacitor 220 (V_{GATE}) is applied to the control input of the pass transistor 202. The pass transistor 202 may be a natural transistor (a natural NFET). A natural transistor may have low threshold voltage (e.g., zero volts), which allows the pass transistor 202 to turn on and conduct current to the load circuit 224 with a low control voltage (low V_{GATE}).

The tracking circuit 204 is coupled between the second current terminal of the pass transistor 202 (the output of the voltage regulator circuit 200) and the control input of the pass transistor 202. The tracking circuit 204 includes a transistor 210 and a transistor 212. The transistor 210 may be a PFET and the transistor 212 may be an NFET. The transistor 210 and the transistor 212 may the same type of transistors as (e.g., have the same parameters as, fabricated using a same process as) transistors of the load circuit 224 that are powered by the output voltage 112. For example, the transistor 210 and the transistor 212 may the same type of transistors as the transistors used in digital logic circuits of the load circuit 224. Because the transistor 210 and the transistor 212 are the same type of transistors as provided in the load circuit 224, the transistor 210 and the transistor 212 have the same (or about the same (approximately equal to)) threshold voltages as the transistors of the load circuit 224.

The transistor 210 is coupled between the output of the voltage regulator circuit 200 (the second current terminal of the pass transistor 202) and the ground terminal. A first current terminal (e.g., source) of the transistor 210 is coupled to the output of the voltage regulator circuit 200, and a second terminal of the transistor 210 is coupled to the ground terminal via the startup circuit 208. A control input (e.g., gate) of the transistor 210 is coupled to the margin circuit 206. The transistor 212 is coupled between the control input of the pass transistor 202 and the margin circuit 206. A first current terminal (e.g., drain) of the transistor 212 is coupled to the control input of the pass transistor 202, and a second current terminal (e.g., source) of the transistor 212 is coupled to the margin circuit 206. A control input (e.g., gate) of the transistor 212 is coupled to the second current terminal of the transistor 210.

As the output voltage 112 increases, the source-gate voltage of the transistor 210 increases. When the source-gate voltage of the transistor 210 exceeds the threshold voltage of the transistor 210, the transistor 210 conducts current, and the voltage at the control input of the transistor 212 increases. When the gate-source voltage of the transistor 212 exceeds the threshold voltage of the transistor 212, the transistor 212 turns on and conducts current (discharges the capacitor 220) to reduce the voltage at the control input of the pass transistor 202. Accordingly, the tracking circuit 204 controls the voltage at the control input of the pass transistor 202 to regulate the output voltage 112 based on the threshold voltages of the transistor 210 and the transistor 212. More specifically, the tracking circuit 204 regulates the output voltage 112 based on the higher of the threshold voltages of the transistor 210 and the transistor 212. If the output voltage 112 rises, then current flow through the transistor 212 increases to decrease V_{GATE}. If the output voltage 112 falls, the current flow through the transistor 212 decreases to allow V_{GATE} to rise.

The margin circuit 206 sets the margin voltage Vx (additional voltage above the higher of the thresholds of the transistor 210 or the transistor 212) provided in the output voltage 112. The margin circuit 206 includes a resistor 214. The margin voltage Vx is generated as the voltage dropped across the resistor 214. A first terminal of the resistor 214 is coupled to the second current terminal of the transistor 212 and the control input of the transistor 210. A second terminal of the resistor 214 is coupled to the ground terminal.

With the tracking circuit 204 and margin circuit 206 described above, the voltage regulator circuit 200 may regulate the output voltage 112 (VSUBREG) as:

VSUBREG=max(V_{TH_210},V_{TH_212})+Vx (Eq. 1)
where:
V_{TH_210} is the threshold voltage of the transistor 210; and
V_{TH_212} is the threshold voltage of the transistor 212.

The startup circuit 208 conducts current to charge the capacitor 220 and generate the voltage (V_{GATE}) that controls the pass transistor 202. The startup circuit 208 includes a current source 216 and a current source 218. The current source 216 is coupled between the power terminal 226 and the input terminal of the pass transistor 202. The current source 218 is coupled between the second current terminal of the transistor 210 and the ground terminal. The current source 216 conducts (sources) current to charge the capacitor 220. The current source 218 conducts (sinks) current from the second current terminal of the transistor 210. The currents conducted by the current source 216 and the current source 218 may be in the range of few (e.g., <10) nanamperes.

FIG. 3 is a schematic diagram of an example voltage regulator circuit 300. The voltage regulator circuit 300 is an implementation of the voltage regulator circuit 100. The voltage regulator circuit 300 is similar to the voltage regulator circuit 200, and includes the pass transistor 202 and the tracking circuit 204 described with reference to the voltage regulator circuit 200. The voltage regulator circuit 300 also includes a transistor 314, a margin circuit 306, and a startup circuit 308. The margin circuit 306 and the startup circuit 308 are implementations of the margin circuit 106, and the start-up circuit 108 respectively. The voltage regulator circuit 300 is coupled to the load circuit 224. The voltage regulator circuit 300 and the load circuit 224 may be parts of a same integrated circuit.

The transistor 314 may be coupled between the tracking circuit 204 and the control input of the pass transistor 202. The transistor 314 may be a natural transistor (e.g., a natural NFET). A first current terminal of the transistor 314 is coupled to the control input of the pass transistor 202, and a second current terminal of the transistor 314 is coupled to the first current terminal of the transistor 212. A control input of the transistor 314 is coupled to the output of the voltage regulator circuit 300. The transistor 314 protects the transistor 212 from the voltage provided at the power terminal 226.

The margin circuit 306 sets the margin voltage Vx (additional voltage above the higher of the thresholds of the transistor 210 or the transistor 212) provided in the output voltage 112. The margin circuit 306 includes a transistor 324 and a transistor 326. The transistor 324 may be a PFET and the transistor 326 may be an NFET. The transistor 326 is diode-connected. A first current terminal (e.g., drain) of the transistor 326 is coupled to a control input (e.g., gate) of the transistor 326 and to the control input of the transistor 210. A second current terminal (e.g., source) of the transistor 326 is coupled to the ground terminal. The transistor 324 is coupled between the transistor 212 and the transistor 326. A first current terminal (e.g., source) of the transistor 324 is coupled to the second current terminal of the transistor 212. A second current terminal (e.g., drain) of the transistor 324 is coupled to the first current terminal of the transistor 326. A control input (e.g., gate) of the transistor 324 is coupled to the ground terminal. The voltage at the first current terminal of the transistor 324 is the margin voltage (Vx). The margin voltage may be provided by the margin circuit 306 as:

Vx=max(V_{SG_224}/V_{GS_226}) (Eq. 2)
where:
V_{SG_224} is the source-to-gate voltage of the transistor 324; and
V_{GS_226} is the gate-to-source voltage of the transistor 326.

The voltage regulator circuit 300 generates the output voltage 112, using Vx provided by the margin circuit 306, in accordance with Eq. 1.

The startup circuit 308 conducts current to charge the capacitor 220 and generate the voltage (V_{GATE}) that controls the pass transistor 202. The startup circuit 308 includes a transistor 316, a transistor 318, a transistor 320, a transistor 322, and a resistor 330. The transistor 316 and the transistor 318 may be PFETs. The transistor 320 and the transistor 322 may be natural transistors (natural NFETs). The transistor 316 and the transistor 318 are connected as a current mirror circuit. The transistor 318 is diode-connected. A first current terminal (e.g., source) of the transistor 318 is coupled to the power terminal 226. A second current terminal (e.g., drain) of the transistor 318 is coupled to the control input (e.g., gate) of the transistor 318 and to the transistor 322. A first current terminal (e.g., source) of the transistor 316 is coupled to the power terminal 226, and a second current terminal (e.g., drain) of the transistor 316 is coupled to the control input of the pass transistor 202. A control input (e.g., gate) of the transistor 316 is coupled to the control input of the transistor 318.

A first current terminal (e.g., drain) of the transistor 320 is coupled to the second current terminal of the transistor 210, and a second current terminal (e.g., source) of the transistor 320 is coupled to the ground terminal via the resistor 330. A control input (e.g., gate) of the transistor 320 is coupled to the ground terminal. A first current terminal (e.g., drain) of the transistor 322 is coupled to the second current terminal of the transistor 318, and a second current terminal (e.g., source) of the transistor 322 is coupled to the second current terminal of the transistor 320 (coupled to ground via the resistor 330). A control input (e.g., gate) of the transistor 322 is coupled to the ground terminal. The resistor 330 limits the current flowing through the transistor 320 and the transistor 322.

When the voltage regulator circuit 300 is regulating the output voltage 112, half the current flowing through the resistor 330 flows through each of the transistor 320 and the transistor 322. When the output voltage 112 is zero volts (when the voltage regulator circuit 300 is off and not providing the output voltage 112 to the load circuit 224), no current flows through the transistor 210 and the transistor 320. Rather, the entire current flowing through the resistor 330 flows through the transistor 322 and the transistor 318. This current is twice the current flowing through the transistor 322 when the output voltage 112 is regulated. The current flowing through the transistor 318 is mirrored through the transistor 316. Accordingly, when the output voltage 112 is zero volts, the increased current flow through the transistor 316 quickly charges the capacitor 220 and turns on the pass transistor 202 to increase the output voltage 112 and reduce the startup time of the voltage regulator circuit 300.

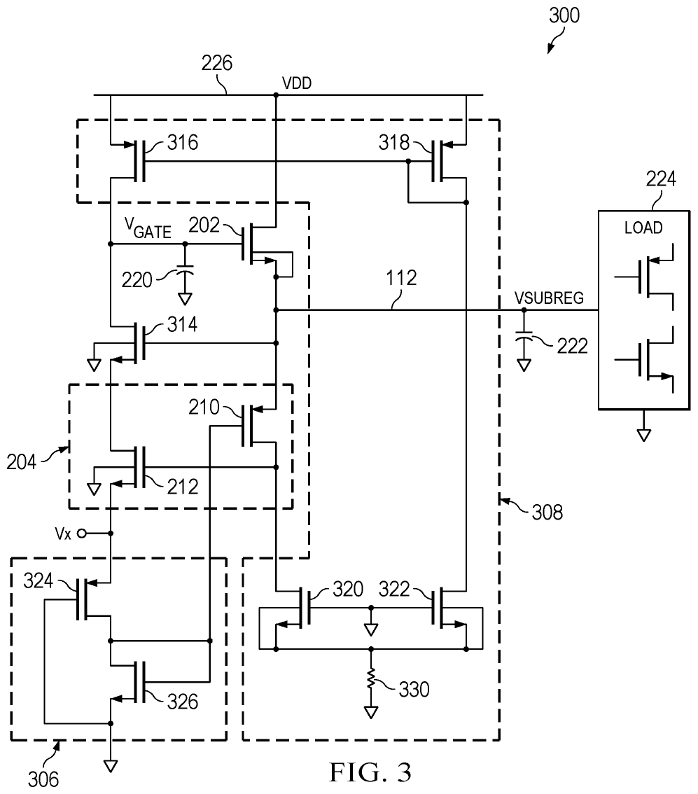

FIG. 4 is a graph showing example tracking of load transistor voltage thresholds in an example of the voltage regulator circuits 100, 200, or 300. FIG. 4 shows voltage ranges 402, 404, and 406. The range 402 represents threshold voltages of the transistors in the load circuit 224 (and the tracking circuit 104 or 204) over temperature and process variation. The range 406 represents the output voltage 112 provided by the voltage regulator circuit 100, 200, or 300. Higher threshold voltage produced by a first process corner causes the voltage regulator circuit to generate a higher output voltage 112. Lower threshold voltage produced by a second process corner causes the voltage regulator circuit to generate a lower output voltage 112. The range 304 represents the margin voltage provided by the margin circuit 106, 206, or 306 over temperature. As the temperature increases, and the threshold voltages of the transistors in the load circuit 224 (and the tracking circuit) decrease, the voltage regulator circuit 200 reduces the output voltage 112. As the temperature decreases, and the threshold voltages of the transistors in the load circuit 224 (and the tracking circuit) increase, the voltage regulator circuit increases the output voltage 112. Accordingly, the output voltage 112 tracks the threshold voltages of the transistors in the load circuit 224 over process and temperature to reduce the current consumed by the load circuit 224 and ensure that adequate operating power supply voltage is provided to the load circuit 224.

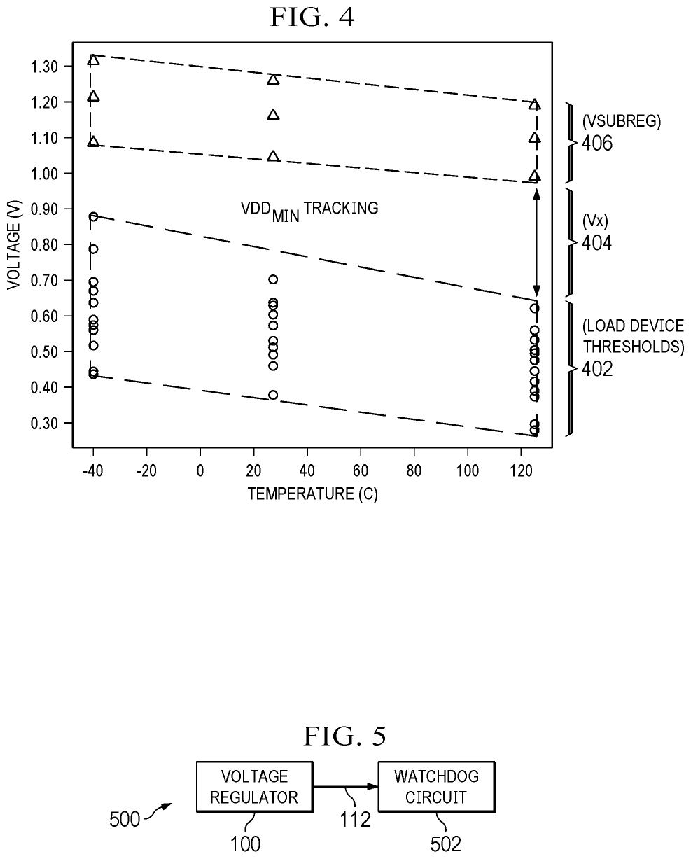

FIG. 5 is a block diagram of an example system 500. The system 500 includes an example of the voltage regulator circuit 100 (or the voltage regulator circuit 200 or 300) and a watchdog circuit 502. The watchdog circuit 502 monitors system activity (e.g., activity of a microcontroller (not shown)) to detect a fault. For example, the watchdog circuit 502 may provide a reset signal to restart the system if no monitored activity is detected within a predetermined interval. Some circuits of the watchdog circuit 502 must remain powered (“always on”) throughout system operation.

The voltage regulator circuit 100 is coupled to the watchdog circuit 502 and provides the output voltage 112 to power the circuits of the watchdog circuit 502 that remain powered throughout system operation. As described herein, the output voltage 112 tracks the thresholds of the transistors in the watchdog circuit 502 to ensure that sufficient operational voltage is provided to the watchdog circuit 502 while reducing the power consumption of the watchdog circuit 502.

In this description, the term “couple” may cover connections, communications, or signal paths that enable a functional relationship consistent with this description. For example, if device A generates a signal to control device B to perform an action: (a) in a first example, device A is coupled to device B by direct connection; or (b) in a second example, device A is coupled to device B through intervening component C if intervening component C does not alter the functional relationship between device A and device B, such that device B is controlled by device A via the control signal generated by device A.

Also, in this description, the recitation “based on” means “based at least in part on.” Therefore, if X is based on Y, then X may be a function of Y and any number of other factors.

A device that is “configured to” perform a task or function may be configured (e.g., programmed and/or hardwired) at a time of manufacturing by a manufacturer to perform the function and/or may be configurable (or reconfigurable) by a user after manufacturing to perform the function and/or other additional or alternative functions. The configuring may be through firmware and/or software programming of the device, through a construction and/or layout of hardware components and interconnections of the device, or a combination thereof.

As used herein, the terms “terminal”, “node”, “interconnection”, “pin” and “lead” are used interchangeably. Unless specifically stated to the contrary, these terms are generally used to mean an interconnection between or a terminus of a device element, a circuit element, an integrated circuit, a device or other electronics or semiconductor component.

A circuit or device that is described herein as including certain components may instead be adapted to be coupled to those components to form the described circuitry or device. For example, a structure described as including one or more semiconductor elements (such as transistors), one or more passive elements (such as resistors, capacitors, and/or inductors), and/or one or more sources (such as voltage and/or current sources) may instead include only the semiconductor elements within a single physical device (e.g., a semiconductor die and/or integrated circuit (IC) package) and may be adapted to be coupled to at least some of the passive elements and/or the sources to form the described structure either at a time of manufacture or after a time of manufacture, for example, by an end-user and/or a third-party.

While the use of particular transistors is described herein, other transistors (or equivalent devices) may be used instead with little or no change to the remaining circuitry. For example, a field effect transistor (“FET”) (such as an n-channel FET (NFET) or a p-channel FET (PFET)), a bipolar junction transistor (BJT—e.g., NPN transistor or PNP transistor), an insulated gate bipolar transistor (IGBT), and/or a junction field effect transistor (JFET) may be used in place of or in conjunction with the devices described herein. The transistors may be depletion mode devices, drain-extended devices, enhancement mode devices, natural transistors or other types of device structure transistors. Furthermore, the devices may be implemented in/over a silicon substrate (Si), a silicon carbide substrate (SiC), a gallium nitride substrate (GaN) or a gallium arsenide substrate (GaAs).

References may be made in the claims to a transistor's control input and its current terminals. In the context of a FET, the control input is the gate, and the current terminals are the drain and source. In the context of a BJT, the control input is the base, and the current terminals are the collector and emitter.

References herein to a FET being “ON” means that the conduction channel of the FET is present and drain current may flow through the FET. References herein to a FET being “OFF” means that the conduction channel is not present so drain current does not flow through the FET. An “OFF” FET, however, may have current flowing through the transistor's body-diode.

Circuits described herein are reconfigurable to include additional or different components to provide functionality at least partially similar to functionality available prior to the component replacement. Components shown as resistors, unless otherwise stated, are generally representative of any one or more elements coupled in series and/or parallel to provide an amount of impedance represented by the resistor shown. For example, a resistor or capacitor shown and described herein as a single component may instead be multiple resistors or capacitors, respectively, coupled in parallel between the same nodes. For example, a resistor or capacitor shown and described herein as a single component may instead be multiple resistors or capacitors, respectively, coupled in series between the same two nodes as the single resistor or capacitor.

While certain elements of the described examples are included in an integrated circuit and other elements are external to the integrated circuit, in other example embodiments, additional or fewer features may be incorporated into the integrated circuit. In addition, some or all of the features illustrated as being external to the integrated circuit may be included in the integrated circuit and/or some features illustrated as being internal to the integrated circuit may be incorporated outside of the integrated. As used herein, the term “integrated circuit” means one or more circuits that are: (i) incorporated in/over a semiconductor substrate; (ii) incorporated in a single semiconductor package; (iii) incorporated into the same module; and/or (iv) incorporated in/on the same printed circuit board.

Uses of the phrase “ground” in the foregoing description include a chassis ground, an Earth ground, a floating ground, a virtual ground, a digital ground, a common ground, and/or any other form of ground connection applicable to, or suitable for, the teachings of this description. In this description, unless otherwise stated, “about,” “approximately” or “substantially” preceding a parameter means being within +/−10 percent of that parameter or, if the parameter is zero, a reasonable range of values around zero.

Modifications are possible in the described embodiments, and other embodiments are possible, within the scope of the claims.

What is claimed is:

1. A circuit comprising:
a transistor coupled between an input voltage terminal and an output voltage terminal, the transistor having a control input;
a tracking circuit having a first input, a second input and an output; in which:
the first input is coupled to the output voltage terminal; and
the second input is coupled to the control input; and
a margin circuit coupled between the output and a ground terminal.

2. The circuit of claim 1, wherein the transistor is a natural transistor.

3. The circuit of claim 1, wherein:
the transistor is a first transistor;
the control input is a first control input;
the tracking circuit includes:
a second transistor coupled between the first control input and the margin circuit, the second transistor having a second control input; and
a third transistor coupled between the output voltage terminal and the second control input, the third transistor having a third control input coupled to the margin circuit.

4. The circuit of claim 3, wherein:
the second transistor is an n-channel field effect transistor; and
the third transistor is a p-channel field effect transistor.

5. The circuit of claim 4, further comprising a load circuit coupled to the output voltage terminal, the load circuit includes a fourth transistor and a fifth transistor, in which:
a threshold voltage of the second transistor is approximately equal to a threshold voltage of the fourth transistor; and
a threshold voltage of the third transistor is approximately equal to a threshold voltage of the fifth transistor.

6. The circuit of claim 3, further comprising a fourth transistor coupled between the first control input and the second transistor, the fourth transistor including a fourth control input coupled to the output voltage terminal.

7. The circuit of claim 6, wherein the fourth transistor is a natural transistor.

8. The circuit of claim 3, wherein the margin circuit includes:
a fourth transistor coupled between the third control input and the ground terminal, in which the fourth transistor includes a fourth control input, the fourth control input is coupled to the third control input, and the third transistor is diode-connected; and
a fifth transistor coupled between the third control input and the fourth transistor, the fifth transistor including a fifth control input coupled to the ground terminal.

9. The circuit of claim 8, wherein:
the fourth transistor is an n-channel field effect transistor; and
the fifth transistor is a p-channel field effect transistor.

10. The circuit of claim 3, further comprising a startup circuit including:
a current mirror circuit including a fourth transistor and a fifth transistor;
a sixth transistor; and
a seventh transistor;
in which:
the fourth transistor is coupled between the input voltage terminal and the first control input, the fourth transistor includes a fourth control input;
the fifth transistor is coupled between the input voltage terminal and the sixth transistor, the fifth transistor includes a fifth control input coupled to the fourth control input, and the fifth transistor is diode-connected;
the sixth transistor is coupled between the fifth transistor and the ground terminal, the sixth transistor includes a sixth control input coupled to the ground terminal; and
the seventh transistor is coupled between the second control input and the ground terminal, the seventh transistor includes a seventh control input coupled to the ground terminal.

11. The circuit of claim 10, wherein the startup circuit includes a resistor coupled between the ground terminal and the sixth transistor, and coupled between the ground terminal and the seventh transistor.

12. The circuit of claim 10, wherein the sixth transistor and the seventh transistor are natural transistors.

13. The circuit of claim 1, further comprising a capacitor coupled between the control input and the ground terminal.

14. A circuit comprising:
a load circuit including a load voltage input, a first transistor having a first threshold voltage and a second transistor having a second threshold voltage; and
a voltage regulator circuit including:
a load voltage output coupled to the load voltage input; and
a tracking circuit configured to provide a load voltage at the load voltage output in which the load voltage tracks the first threshold voltage and the second threshold voltage.

15. The circuit of claim 14, wherein the voltage regulator circuit includes:
an input voltage terminal; and
a pass transistor coupled between the input voltage terminal and the load voltage output, the pass transistor having a control input;
in which the tracking circuit is coupled between the load voltage output and the control input.

16. The circuit of claim 15, wherein the voltage regulator circuit includes a margin circuit coupled between the tracking circuit and a ground terminal, in which the margin circuit is configured to set the load voltage to be greater than the first threshold voltage and the second threshold voltage by a predetermined margin voltage.

17. The circuit of claim 16, wherein the tracking circuit includes:
a third transistor coupled between the control input and the margin circuit, the third transistor including a third control input; and
a fourth transistor coupled between the load voltage output and the third control input, the fourth transistor including a fourth control input coupled to the margin circuit.

18. The circuit of claim 17, wherein the voltage regulator circuit includes a startup circuit coupled to the pass transistor and the tracking circuit, the startup circuit configured to provide a current to the control input, the current based on the load voltage.

19. The circuit of claim 14, wherein the first transistor and the second transistor are components of a watchdog circuit.

20. A circuit comprising:
a load circuit including a load voltage input, a first transistor having a first threshold voltage and a second transistor having a second threshold voltage;
a voltage regulator circuit including:
an input voltage terminal;
a load voltage output coupled to the load voltage input;
a pass transistor coupled between the input voltage terminal and the load voltage output, the pass transistor having a control input;
a tracking circuit coupled between the load voltage output and the control input, the tracking circuit configured to provide a load voltage at the load voltage output in which the load voltage tracks the first threshold voltage and the second threshold voltage;
a margin circuit coupled between the tracking circuit and a ground terminal, in which the margin circuit is configured to set the load voltage to be a predetermined margin voltage greater than the first threshold voltage and the second threshold voltage; and
a startup circuit coupled to the pass transistor and the tracking circuit, the startup circuit configured to provide a current to the control input, the current based on the load voltage.
